(19) United States
(12) Patent Application Publication
(10) Pub. No.: US 2017/0091559 A1
(43) Pub. Date: Mar. 30, 2017

(54) CAMERA MONITOR SYSTEM FOR A VEHICLE

(71) Applicants: Valeo North America, Inc., Troy, MI (US); Connaught Electronics Ltd., Tuam (IE)

(72) Inventors: Miguel Hurtado, Troy, MI (US); Amine Taleb-Bendiab, Troy, MI (US); Heinz Mattern, Troy, MI (US); Christopher Gorman, Troy, MI (US); Andrey Iakimov, Troy, MI (US)

(73) Assignees: Valeo North America, Inc., Troy, MI (US); Connaught Electronics Ltd., Tuam (IE)

(21) Appl. No.: 14/869,669

(22) Filed: Sep. 29, 2015

(51) Int. Cl. G06K 9/00; H04N 5/232; B60Q 9/00; H04N 7/18

(52) U.S. Cl. CPC G06K 9/00771; H04N 7/181; H04N 5/23293; B60Q 9/008

(57) ABSTRACT

A camera monitor system for a vehicle, including a single camera disposed on a rear of the vehicle comprising a field of view (FoV), a processor configured to process image data received by the single camera to obtain an image of a vehicle surrounding, and an output device configured to display the image of the vehicle surrounding. The FoV is a rearview comprising a horizontal FoV angle ranging from 50° to 150.

### BACKGROUND

One or more embodiments of the invention are directed to a camera monitor system configured to provide a driver of a vehicle with a surrounding view of the vehicle.

### SUMMARY

In general, in one aspect, one or more embodiments disclosed herein relate to a camera monitor system for a vehicle, comprising: a single camera disposed on a rear of the vehicle comprising a field of view (FoV), wherein the FoV is a rearview comprising a horizontal FoV angle ranging from 50° to 150°; a processor configured to process image data received by the single camera to obtain an image of a vehicle surrounding; and an output device configured to display the image of the vehicle surrounding.

In another aspect, one or more embodiments disclosed herein relate to a camera monitor system for a vehicle, comprising: a first camera disposed on a rear of the vehicle comprising a first field of view (FoV), wherein the first FoV is a first rearview; a second camera disposed on the rear of the vehicle comprising a second FoV, wherein the second FoV is a second rearview; a processor configured to process the first FoV and the second FoV to obtain an image of a vehicle surrounding, wherein the combined FoV comprises a horizontal FoV angle ranging from 50° to 300°; and an output device is configured to display the image of the vehicle surrounding.

In yet another aspect, one or more embodiments disclosed herein relate to a monitoring method comprising: disposing a single camera on a vehicle, the single camera has a field of view (FoV); determining that an object of interest has entered the FoV; and displaying the object of interest on an output device, wherein camera has a field of view (FoV); determining that an object of interest has entered the FoV; and displaying the object of interest on an output device, wherein the FoV is a rearward view comprising a horizontal FoV angle ranging from 50° to 150°.

Other aspects and advantages of the invention will be apparent from the following description and the appended claims.

### BRIEF DESCRIPTION OF DRAWINGS

FIG. 1 shows a camera monitor system according to one or more embodiments of the invention.

FIG. 2A shows a vehicle mounted with a camera monitor system according to one or more embodiments of the invention.

FIG. 2B shows a vehicle mounted with a camera monitor system according to one or more embodiments of the invention.

FIG. 2C shows a vehicle mounted with a camera monitor system according to one or more embodiments of the invention.

FIG. 2D shows a vehicle mounted with a camera monitor system according to one or more embodiments of the invention.

FIG. 2E shows a vehicle mounted with a camera monitor system according to one or more embodiments of the invention.

FIG. 2F shows a vehicle mounted with a camera monitor system according to one or more embodiments of the invention.

FIG. 2G shows a vehicle mounted with a camera monitor system according to one or more embodiments of the invention.

FIG. 2H shows a vehicle mounted with a camera monitor system according to one or more embodiments of the invention.

FIG. 3A shows an interior of a vehicle having output devices according to one or more embodiments of the invention.

FIG. 3B shows an output device of a camera monitor system according to one or more embodiments of the invention.

FIG. 3C shows an output device of a camera monitor system according to one or more embodiments of the invention.

FIG. 3D shows an output device of a camera monitor system according to one or more embodiments of the invention.

FIG. 3E shows an output device of a camera monitor system according to one or more embodiments of the invention.

FIG. 4 shows a field of view of a camera monitor system according to one or more embodiments of the invention compared to a field of view of conventional rearview mirrors with the corresponding blind zones.

FIG. 5A shows a field of view of a camera monitor system according to one or more embodiments of the invention.

FIG. 5B shows a field of view of a camera monitor system according to one or more embodiments of the invention.

FIG. 6A shows a vehicle mounted with a camera monitor system according to one or more embodiments of the invention. Example blind zone calculations are discussed in reference to FIG. 6A.

FIG. 6B shows a vehicle mounted with a camera monitor system according to one or more embodiments of the invention. Example blind zone calculations are discussed in reference to FIG. 6B.

FIG. 7 shows a blind zone comparison graph for camera monitor systems according to one or more embodiments of the invention.

### DETAILED DESCRIPTION

Specific embodiments will now be described in detail with reference to the accompanying figures. Like elements in the various figures are denoted by like reference numerals for consistency. Like elements may not be labeled in all figures for the sake of simplicity.

In the following detailed description, numerous specific details are set forth in order to provide a more thorough understanding of one or more embodiments of the invention. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create a particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents, unless the context clearly dictates otherwise. Thus, for example, reference to “a field of view” includes reference to one or more of such views, whereas reference to “a single camera” includes reference to only one such camera. Further, it is to be understood that “or,” as used throughout this application, is an inclusive or, unless the context clearly dictates otherwise.

Terms like “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

One or more embodiments of the invention are generally directed to a camera monitor system comprising, for example, a camera and a display configured to replace European Class I and Class III mirrors—definitions of different mirror classes are set forth in Table II below (further, corresponding United States terminologies are also provided in Table II). However, one of ordinary skill in the art would appreciate that the camera monitor system may be reconfigured to replace mirrors of other classes. In one or more embodiments of the invention, the camera monitor system includes only a single camera and a single display. In other embodiments, the camera monitor system includes a plurality of cameras and a plurality of displays.

In one or more embodiments of the invention, by disposing the camera monitor system on, for example, a rear of a vehicle (definitions of “vehicle” per 2007/46/EC are set forth in Table I) and ensuring that the camera monitor system's field of view covers both Class I and Class III requirements as set forth by the United Nations Economic Commission for Europe Regulation No. 46 (“ECE-46”), a car manufacturer is able to remove Class I and Class III mirrors and still comply with said regulatory requirements on select vehicle types without affecting the driver's ability to see the left side view, the right side view, and the rear view while operating the vehicle. Of course, one of ordinary skill in the art would appreciate that the camera monitor system can be reconfigured (i.e., disposed at different positions, adapted with different specifications, etc.) to cover standards of other jurisdictions—including the Federal Motor Vehicle Safety Standard No. 111 (“FMVSS 111”) of the United States.

Further, research has shown that the removal of Class III mirrors not only reduces costs but also drastically reduces drag, improves gas mileage, and reduces CO₂ emission. For example, the removal of Class III mirrors has been shown to reduce at least 1.11 g CO₂/km.

TABLE I
Vehicle Definition per 2007/46/EC

```
Category M - Motor vehicles with at least four wheels designed and constructed for the carriage of passengers
    M1 - Vehicles designed and constructed for the carriage of passengers and comprising no more than
    eight seats in addition to the driver's seat.
    M2 - Vehicles designed and constructed for the carriage of passengers, comprising more than eight
    seats in addition to the driver's seat, and having a maximum mass not exceeding 5 tonnes,
    M3 - Vehicles designed and constructed for the carriage of passengers, comprising more than eight
    seats in addition to the driver's seat and having a maximum mass exceeding 3 tonnes.
Category N - Motor vehicles with at least four wheels designed and constructed for the carriage of goods.
    N1 - Vehicles designed and constructed for the carriage of goods and having a maximum mass not
    exceeding 3.5 tonnes.
    N2 - Vehicles designed and constructed for the carriage of goods and having a maximum mass
    exceeding 3.5 tonnes but not exceeding 12 tonnes.
    N3 - Vehicles designed and constructed for the carriage of goods and having a maximum mass
    exceeding 12 tonnes.
Category O - Trailers (including semi-trailers)
    O1 - Trailers with a max. mass not exceeding 0.75 tonnes,
    O2 - Trailers with a max. mass exceeding 0.75 tonnes but not exceeding 3.5 tonnes.
    O3 - Trailers with a maximum mass exceeding 3.5 tonnes but not exceeding 10 tonnes.
    O4 - Trailers with a maximum mass exceeding 10 tonnes.
Category L - Motor vehicles with less than four wheels
    L3 - A two-wheeled vehicle with an engine cylinder capacity in the case of a thermic engine
    exceeding 50 cm3 or whatever the means of propulsion a max design speed exceeding 50 km/h.
```

TABLE II
Classes of Mirrors for Select Vehicle Types
ECE-R 46/FMVSS 111

```
Interior of Vehicle
    Class I Interior Rearview Mirror/Inside Rearview Mirror, required per FMVSS 111
      Compulsory for Passenger Vehicle Type (M1) and Light Trucks <= 3.5 t (N1)
Exterior of Vehicle
    Class II Exterior Sideview Mirror Large/Main Outside Rearview Mirror Large, required per FMVSS 111
      Compulsory for Passenger Vehicles more than 8 seats and <= 5 t (M2)
      Compulsory for Passenger Vehicles more than 8 seats and >5 t (M3)
      Compulsory for Commercial Trucks >3.5 t and <= 12 t (N2)
      Compulsory for Commercial Trucks  >12 t (N3)
    Class III Exterior Sideview Mirror Small/Main Outside Rearview Mirror Small, required per FMVSS 111
      Compulsory for Passenger Vehicle Type (M1) and Light Trucks <= 3.5 t (N1)
    Class IV Wide Angle Mirror/Wide Angle Mirror, optional per FMVSS 111
      Compulsory for Trucks <= 7.5 t (N2) both sides only if Class V can be fitted
      Compulsory for Trucks > 7.5 t (N2) both sides
      Compulsory for Trucks > 12 t (N3) both sides
    Class V Close Proximity Mirror/Door-Mounted Look-Down Mirror, optional per FMVSS 111
      Compulsory for Trucks <= 7.5 t (N2) only Passenger Side, Driver's Optional
      Compulsory for Trucks > 7.5 t (N2) only Passenger Side, Driver's Optional
      Compulsory for Trucks > 12 t (N3) only Passenger Side, Driver's Optional
Front of Vehicle
    Class VI Front Mirror/Front Mirror, optional per FMVSS 111
      Compulsory for Trucks > 7.5 t (N2) front mirror at least 2 m above ground
      Compulsory for Trucks > 12 t (N3) front mirror at least 2 m above ground
```

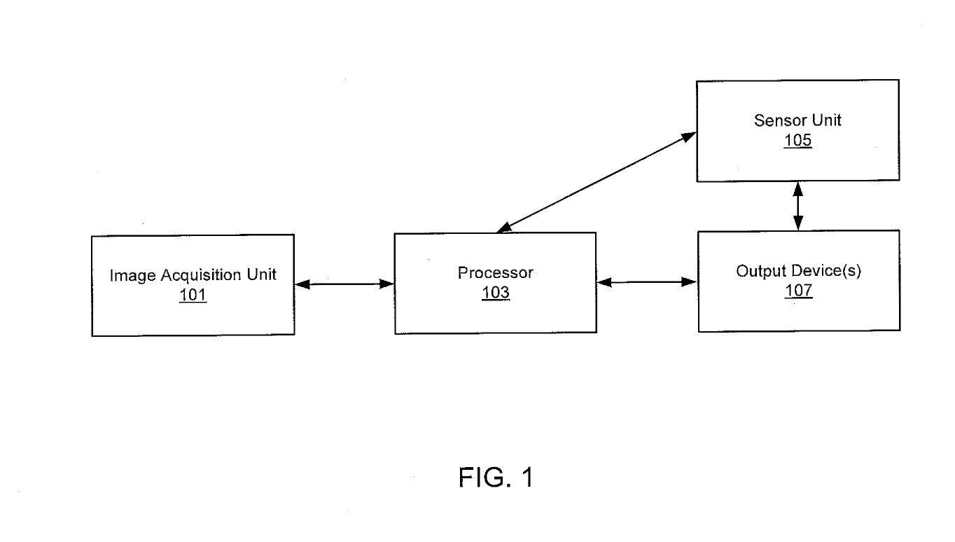

FIG. 1 shows a camera monitor system according to one or more embodiments of the invention. As shown in FIG. 1, the system includes multiple components—an image acquisition unit (101), a processor (103), a sensor unit (105), output device(s) (107), a memory (not shown), etc. The various components of the system may communicate directly or indirectly with one another. Each of these components is described below in more details.

The image acquisition unit (101) is an image sensor hardware (e.g., a camera, a camcorder, a smart phone, a personal digital assistant (PDA), etc.). The image acquisition unit (101) may communicate with the processor (103) or the output device(s) (107) directly or indirectly using any wired or wireless (e.g., wifi, cellular, etc.) connections. The image acquisition unit (101) has a field of view. The image acquisition (101) is configured to be mounted on a vehicle to capture images of a surrounding view of the vehicle that are within the field of view. The field of view must satisfy the official regulations to cover specified outside areas around the vehicle. For the purposes of discussion only, the image acquisition unit (101) is a camera. The camera may be any type of suitable camera, now known or later developed, such as video cameras, CMOS imaging arrays, CCD cameras, etc. The camera may be a wide-angle camera designed to capture more of the surroundings of a vehicle using, for example, a fisheye lens or other well-known types of lenses. Further, in one or more embodiments of the invention, the camera may be a 1-2 Megapixel camera.

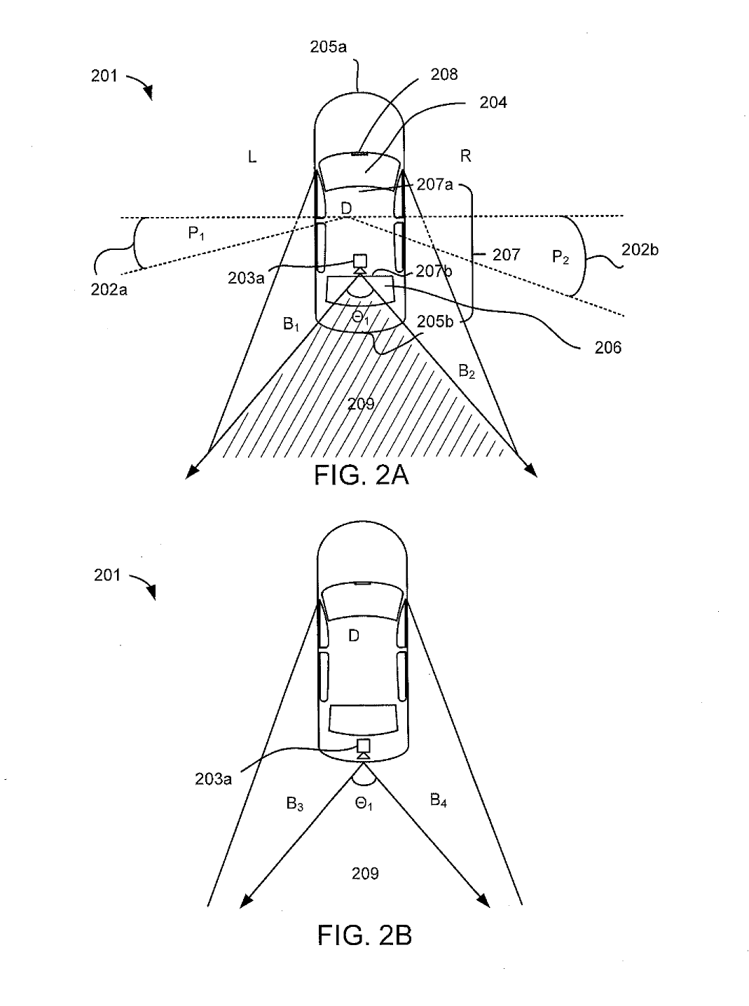

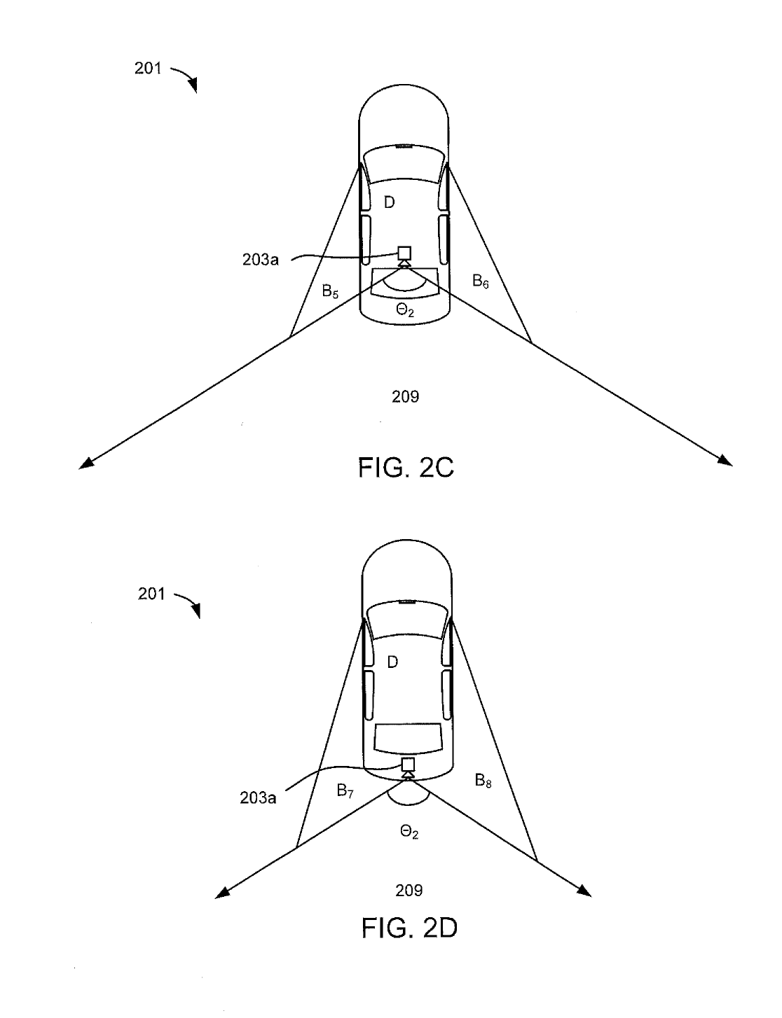

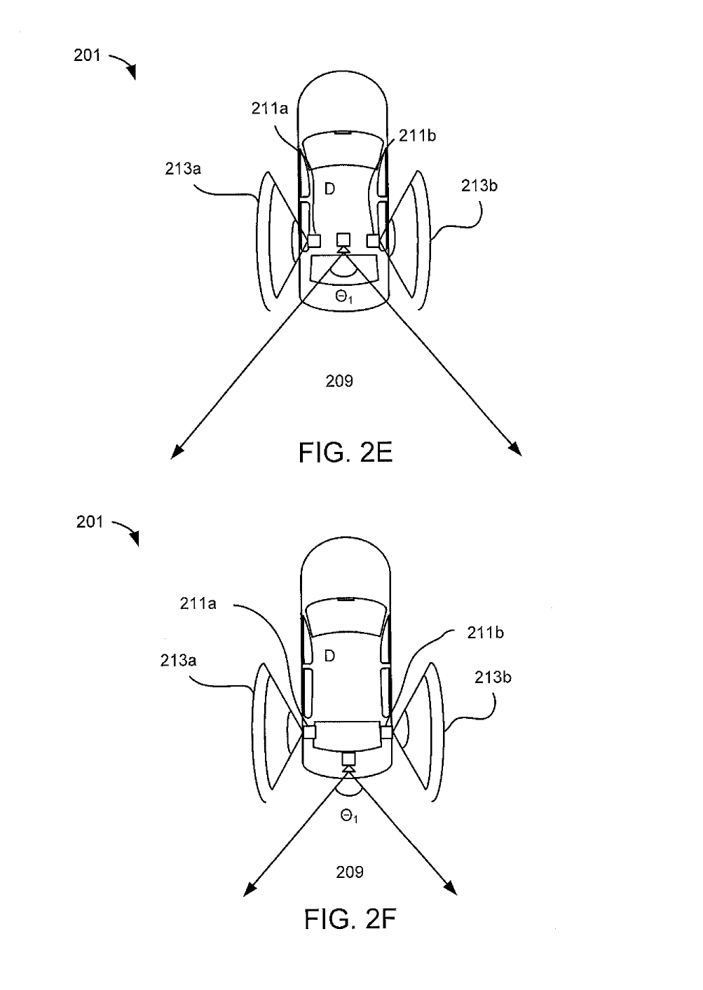

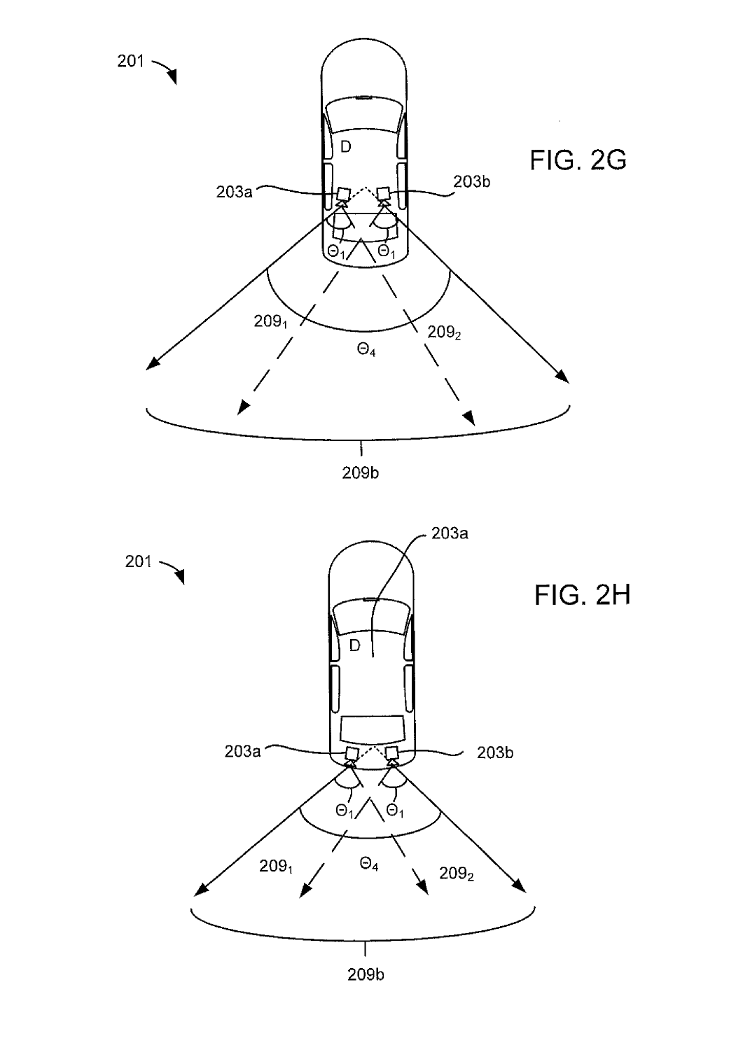

Placement of the camera (101) on the vehicle is not limited and can vary depending on vehicle type, placement of the image acquisition unit (101), etc. Example placements of the camera monitor system are described in more details with respect to FIGS. 2A-2H. In one or more embodiments of the invention, the camera is a single rearview camera, positioned on the rear of the vehicle.

The processor (103) is a hardware processor (e.g., an integrated circuit for processing instructions). The processor (103) may be one or more cores, or micro-cores of a processor. The processor (103) is configured to receive image data from the camera (101). The processor (103) may process the image data using any known image processing technique and/or algorithm for processing image data (e.g., image registration/compositing, blending, edge detection, image synthesis, image compression, object injection, object proposal, etc.). The processor (103) may receive image data from a plurality of image acquisition units and combine such image data into a combined image in a manner that accurately shows the surrounding view of the vehicle to a driver via the output device(s) (107). If need be, the processor (103) may, working in conjunction with the sensor unit (105), adjust contrast, brightness, etc., of the captured images before displaying the same to the driver. In one or more embodiments of the invention, when the camera monitor system includes a single camera mounted on the vehicle, the processor is configured to obtain image data captured by the single camera, process the image data in accordance with various environmental parameters and for purposes of display on the output device(s) (107), and transmit the processed image data to the output device(s) (107).

The sensor unit (105) may be any transducer configured to be disposed on the vehicle. The sensor unit (105) is configured to detect and/or measure one or more parameters associated with the surrounding of the vehicle. The sensor unit (105) may include one or more sensors disposed on the vehicle—an infrared sensor, a luminescence sensor, an ultrasonic sensor, etc. In one or more embodiments of the invention, the sensor unit (105) is configured to detect other vehicles or objects of interest that may be in blind zone(s) of the driver of the vehicle. In one or more embodiments of the invention, the blind zone(s) may be outside of the field of view of the image acquisition unit (101). However, embodiments of the invention are not limited thereto. Specifically, objects of interest may be partially or completely within the field of view of the image acquisition unit (101). Objects of interest detected by the sensor unit (105) may include, but is not limited to, pedestrians, cyclists, animals, hazardous obstacles on the road, etc. Placement of the sensor unit (105) on the vehicle is not limited and can vary depending on vehicle type, placement of the camera (101), etc. Example placements of the sensor unit (105) are described in more details with respect to FIG. 2E and FIG. 2F.

In one or more embodiments of the invention, the memory (not shown) may be, for example, random access memory (RAM), cache memory, flash memory, etc., configured to store image data from the camera (101). The memory may be coupled to or separate from the processor (103). The memory may also be stored in the output device(s).

The output device(s) (107) may be any display hardware, now known or later developed, that is configured to display the surrounding view of the vehicle to the driver. For example, the output device(s) may be a cathode ray tube display (CRT), a light-emitting diode display (LED), an electroluminescent display (ELD), a plasma display panel (PDP), a liquid crystal display (LCD), an organic light-emitting diode (OLED), a laser color video display, an interferometric modulator display, head-up display (HUD), etc. Further, the output device(s) (107) may be a reconfigurable display in which a user/driver may select the type of view and the information to be displayed on the hardware display. The reconfigurable display may be configured to display camera image data and sensor data from the camera monitor system, as well as other auxiliary information such as navigation information, radio/media player settings, directory information, vehicle warning information, auditory/visual warnings, ADAS information etc.

The output device(s) (107) may be disposed anywhere within or outside the vehicle so long as it (107) is visible to the driver. In one or more embodiments of the invention, the output device(s) (107) may be a display that replaces a rearview mirror. In one or more embodiments of the invention, the output device(s) (107) may be a dual display within a rearview mirror, capable of displaying camera image data as well as functioning as a rearview mirror for the driver. In one or more embodiments of the invention, the output device(s) (107) may be a portion of a windshield of the vehicle. In one or more embodiments of the invention, the output device(s) (107) may be a plurality of separate displays.

To satisfy regulatory requirements, the camera (101) and the output device(s) (107) must, respectively, obtain and display images of adequate resolution. The minimum resolution set by the various regulations account for the resolving power of normal eyesight.

Generally, 20/20 vision is a term used to express normal visual acuity (the clarity or sharpness of vision) measured at a distance of 20 feet. If a driver has 20/20 vision, the driver can see clearly at 20 feet what should normally be seen at that distance. If the driver has 20/x vision, the driver must be as close as 20 feet to see what a person with normal vision can see at x feet. A conversion chart for various metrics to measure a driver's eyesight is shown in Table III.

ISO 16505:2015 sets forth the minimum safety, ergonomic, and performance requirements for camera monitor systems to replace Class I and Class III mirrors (i.e., interior rearview mirror and exterior side view mirrors). Of course, the camera monitor system according to one or more embodiments can be reconfigured to satisfy ISO 16505:2015 and other regulatory requirements, which are living documents subject to amendment.

Table IV provides representative examples of minimum resolutions of the camera (101) required to satisfy the ISO 16505:2015 for a passenger vehicle application. Note that the minimal angular resolution increases for drivers with less resolving power (e.g., drivers with 20/30 vision or 1.43˜1.5 arcmin). As of the filing date of this application, 1.43 arcmin is the maximum angular resolution accepted by ISO 16505:2015. The aspect ratio of the camera monitor system according to Table IV may be, for example, 24:9.

TABLE IV
Camera Resolutions for Camera Monitor System
FMVSS 111 Standard

| FoV Hor | FoV Ver |
|---|---|
| 40 deg | 15 deg |
| Ang Resolution | Min Resolution |
| 1 arcmin | 2.1 MegaPix |
| 1.25 arcmin | 1.4 MegaPix |
| 1.41 arcmin | 1.1 MegaPix |

Table V provides representative examples of minimum resolutions of the camera (101) required to satisfy ECE-R46 and ISO 16505:2015. As indicated above, the angular resolution cannot be above 1.43 arcmin. The aspect ratio of the camera monitor system according to Table V may be, for example, 2:1.

TABLE V
Camera Resolutions for Camera Monitor System
ECE-R46

| FoV Hor | FoV Ver |
|---|---|
| 80 deg | 20 deg |
| Ang Resolution | Min Resolution |
| 1 arcmin | 5.5 MegaPix |
| 1.20 arcmin | 3.8 MegaPix |
| 1.43 arcmin | 2.2 MegaPix |

To accommodate the camera resolutions indicated above and assuming a unit magnification, a 1-1 correspondence between the camera and the display, and a zero distortion, the display would have to be at least 18.7″. In certain jurisdictions, image data may be processed by the processor (103) such that the displayed images are a magnified surrounding view of the vehicle. In these cases, the display may be reduced in size. For example, assuming a 0.5 magnification, 1-1 correspondence between the camera and the display, and zero distortion, the display would have to be at least 18″. One of ordinary skill in the art would appreciate that the screen sizes may be smaller if a plurality of displays are used instead of only a single display to satisfy regulatory requirements.

FIG. 2A shows a vehicle (201) mounted with a camera monitor system according to one or more embodiments of the invention. The vehicle (201) may be of any vehicle type as set forth by, for example, the National Highway Traffic Safety Administration—including a passenger car, a multipurpose passenger vehicle, a truck, a bus, a motorcycle, a motor driven cycle, a trailer, a low-speed vehicle, a pole trailer, etc. Preferably, the camera monitor system is mounted on a M1 or N1 category vehicle (See Table I).

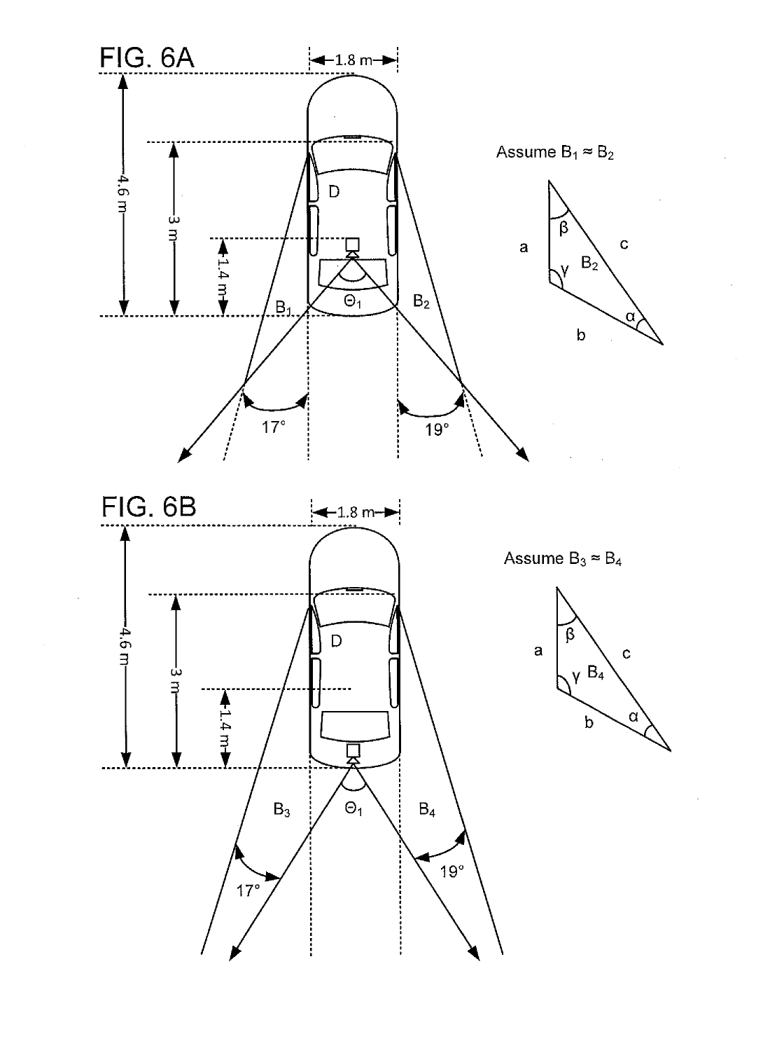

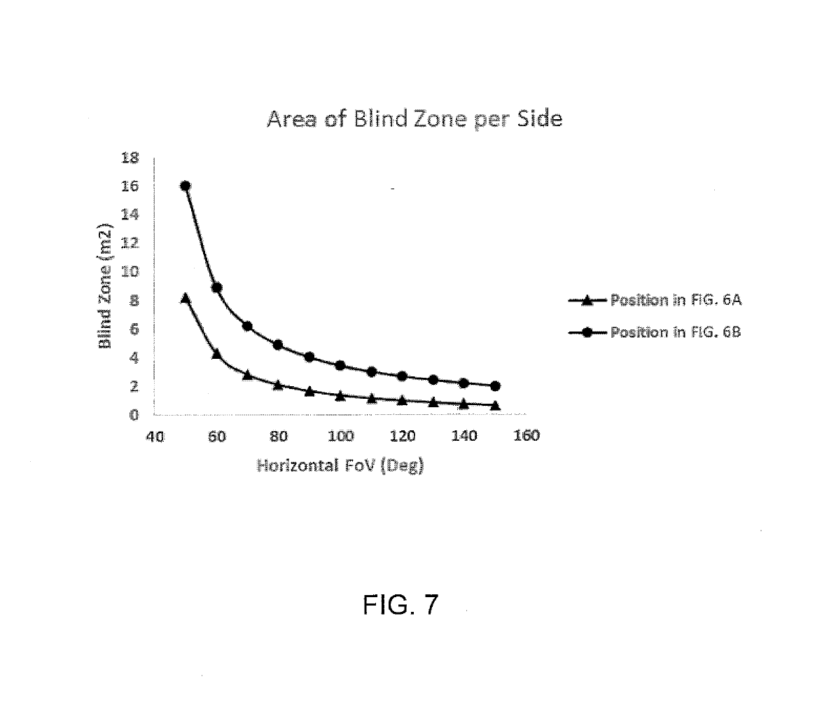

For the purposes of discussion only, the camera monitor system according to one or more embodiments of the invention is mounted on a four-door passenger car. The vehicle (201) comprises a front windshield (204), a rear windshield (206), and a rear area (207). The rear area (207) includes a front zone (207a), a rear zone (207b), and a back (205b). The front zone (207a) is defined as the foremost area of the rear area (207)—just after where the windshield (204) ends and closest to the position of the driver normally operating the vehicle. The rear zone (207b) is defined as the rearmost area of the rear area (207)—just before where the rear windshield (206) starts. The back (205b) is defined as an area at the rear of the vehicle. For example, in one or more embodiments of the invention, the back (205b) may be a trunk lid close to the typical placement of a license plate. The back (205b) may also include the rear bumper of the vehicle. For more details, example measurements of the four-door passenger car are shown and described in reference to FIGS. 6A and 6B.

In FIG. 2A, although the driver (D) is shown to be seated on the left side (L) of the vehicle, the camera monitor system according to one or more embodiments of the invention can also be deployed on a vehicle having a driver (D) seated on the right side (R) of the vehicle.

As shown in FIG. 2A, the driver (D) sits facing the front (205a) of the vehicle. The driver's position is nearer to the front (205a) and further away from the back (205b) of the vehicle. That is, the distance between the driver (D) and the front (205a) is smaller than the distance between the driver (D) and the back (205b) of the vehicle. The driver has a far left peripheral view (P₁) having a left peripheral horizontal field of view angle (202a) of approximately 20° and a far right peripheral view (P₂) having a right peripheral horizontal field of view angle (202b) of approximately 30°. The far left (P₁) and far right (P₂) peripheral views can vary from one individual to another depending on his or her personal attributes (i.e., vision, age, etc.).

In FIG. 2A, a camera (203a) is mounted on the rear zone (207b) of the rear (207). The camera (203a) has a field of view (209). The field of view has a horizontal field of view angle between 50° and 150° and a vertical field of view angle between 15° and 70°. Those skilled in the art will appreciate that the field of view (209) of a camera may be calculated based on the geometry and the dimensions of the vehicle (201). For purposes of discussion only, in one or more embodiments of the invention, the horizontal field of view angle Θ₁ is 52° and the vertical field of view angle is 67°, unless stated otherwise. The vehicle (201) may be without wing mirrors or without a rearview mirror (208) because the field of view (209) of the camera (203a) adequately covers the field of views of the wing mirrors and the rearview mirror, whether considered individually or as a combined field of view of three mirrors. Although blind zones (B₁, B₂) may be newly created due to the placement of camera (203a) and the absence of wing mirrors, these blind zones (B₁, B₂) may be smaller in area than that of the wing mirrors depending on the placement of the camera (203a). In addition, the blind zones (B₁, B₂) may be adjusted by modifying the field of view of the camera (203a). Example blind zone area calculations are described in more detail with reference to FIGS. 6A-7. In one or more embodiments of the invention, the camera (203a) is mounted such that the field of view (209) complies with various regulatory requirements including the FMVSS 111 Standard in the United States and the ECE-R46 Regulation in Europe. Further, the placement of the camera (203a) may be modified to fulfill regulatory requirements in jurisdictions outside of the U.S. and Europe—including Japan, China, etc.

FIG. 2B shows a vehicle (201) mounted with a camera monitor system according to one or more embodiments of the invention. FIG. 2B is substantially similar to FIG. 2A. Accordingly, components and functions that have already been described will be omitted for the sake of brevity.

One difference between FIG. 2A and FIG. 2B lies in the placement of the camera (203a) of the camera monitor system. In FIG. 2B, the camera (203a) is mounted near the back (205b) of the vehicle (201). For example, the camera (203a) may be mounted on a trunk lid close to the typical placement of a license plate. Although the horizontal field of view angle of the camera (203a) in FIG. 2B remains Θ₁, the field of view (209) that can be seen by the driver is reduced in area. Further, the blind zones (B₃, B₄) created due to the placement of the camera (203a) are larger than those of the blind zones (B₁, B₂). As discussed above, example blind zone area calculations are described in more detail with reference to FIGS. 6A-7.

FIG. 2C shows a vehicle (201) mounted with a camera monitor system according to one or more embodiments of the invention. FIG. 2C is substantially similar to FIG. 2A.

One difference between FIG. 2A and FIG. 2C lies in the field of view (209) of the camera (203a). Specifically, although the camera (203a) in FIG. 2C, as in FIG. 2A, is mounted near the back (205b) of the vehicle (201), the field of view (209) in FIG. 2C has a horizontal field of view angle of Θ₂, where Θ₂ 125°. And because Θ₂ is greater than Θ₁, the field of view (209) in FIG. 2C is larger than that in FIG. 2A. Furthermore, because the field of view (209) in FIG. 2C is larger than that in FIG. 2A, blind zones (B₅, B₆) are smaller than the blind zones (B₁, B₂). As discussed above, example blind zone area calculations are described in more detail with reference to FIGS. 6A-7.

FIG. 2D shows a vehicle mounted with a camera monitor system according to one or more embodiments of the invention. FIG. 2D is substantially similar to FIG. 2B.

One difference between FIG. 2B and FIG. 2D lies in the field of view (209) of the camera (203a). Specifically, although the camera (203a) in FIG. 2D, as in FIG. 2B, is mounted on the rear zone (207b) of the rear area (207) of the vehicle, the field of view (209) in FIG. 2D has a horizontal field of view angle of Θ₂, where Θ₂≈125°. And because Θ₂ is greater than Θ₁, the field of view (209) in FIG. 2D is larger than that in FIG. 2B. Furthermore, because the field of view (209) in FIG. 2D is larger than that in FIG. 2B, blind zones (B₇, B₈) are smaller than the blind zones (B₃, B₄), As discussed above, example blind zone area calculations are described in more details in reference to FIGS. 7A-8.

FIG. 2E shows a vehicle mounted with a camera monitor system according to one or more embodiments of the invention. FIG. 2E is substantially similar to FIG. 2A.

In FIG. 2E, a sensor unit is disposed on the vehicle (201). The sensor unit, as discussed above, include any type of sensor suitable for detecting objects of interest or reporting vehicle surroundings information to the driver. For purposes of discussion only, the sensor unit comprises two ultrasonic sensors (211a, 211b)—one on the left side (L) of the vehicle (201) and another on the right side (R) of the vehicle (201). The ultrasonic sensors (211a, 211b) each have a sensor zone (213a, 213b). The sensor zone (213a, 213b) may partially or completely cover a blind zone outside the field of view (209) of the camera. Upon detecting a presence of an object of interest (e.g., another vehicle, a pedestrian, an animal, etc.) or a hazardous condition in the sensing zone (213a, 213b), the sensor unit causes a signal to be displayed on the output device(s) to the driver of the vehicle (201). The displayed signal is designed to, for example, bring attention to such detected objects to the driver and warn the driver of a potential hazardous condition. The displayed signal may be any suitable visual signal, such as an illuminated icon, highlighting, color changes, etc. Further, the displayed signal may be accompanied by, for example, an auditory signal such as a beeping noise.

FIG. 2F shows a vehicle mounted with a camera monitor system according to one or more embodiments of the invention. FIG. 2F is substantially similar to FIG. 2E.

One difference between FIG. 2E and FIG. 2F lies in the placement of the camera. Another difference lies in the placement of the sensor unit. Specifically, the ultrasonic sensors (211a, 211b) are disposed closer to the back of the vehicle (201) in comparison to those in FIG. 2E. As discussed above, the placement of the sensor unit (105) can vary depending on the placement of the camera. The placement of the sensor unit and the placement of the camera may be considered in combination to minimize blind zones and meet various regulatory requirements. As such, although the ultrasonic sensors (211a, 211b) are shown to be disposed on two sides of the rear area (207) of the vehicle, they can be disposed, for example, anywhere on the vehicle, for example, on the rear doors, near the rear wheels, etc. Further, although FIG. 2F shows only two ultrasonic sensors, the number can vary to maximize blind zone coverage.

FIG. 2G shows a vehicle (201) mounted with a camera monitor system according to one or more embodiments of the invention. Specifically, in FIG. 2G, the camera monitor system comprises two rearview cameras (203a, 203b) mounted on the rear zone (207b) of the rear. For example, the two rearview camera may be mounted at the top of the rear windshield or where the rear windshield meets the roof of the vehicle. Each camera (203a, 203b) has a field of view (209₁, 209₂). Each field of view (209₁, 209₂) has a horizontal field of view angle Θ₁. Although FIG. 2G shows each of the two cameras (203a, 203b) as having a horizontal field of view angle Θ₁, one of ordinary skill in the art would appreciate that the horizontal field of view angle of one camera (203a) may be different from another (203b).

In one or more embodiments of the invention, two cameras (203a, 203b) may be used in the camera monitor system to minimize the blind zones. As discussed above, the processor may receive image data from a plurality of image acquisition units and combine such image data into a combined image in a manner that accurately shows the surrounding view of the vehicle to a driver via the output device(s). In FIG. 2G, the processor may be configured to receive image data from the two cameras (203a, 203b) and combine such image data to display, to the driver, an image which shows the driver information captured in the combined field of view (209b). The combined field of view (209b) may have a combined horizontal field of view angle Θ₄, which may be larger than that of each of the individual field of view (209₁, 209₂) of the cameras (203a, 203b). In one or more embodiments of the invention, Θ₄ ranges from 50° to 300°.

FIG. 2H shows a vehicle (201) mounted with a camera monitor system according to one or more embodiments of the invention. FIG. 2H is substantially similar to FIG. 2G.

One difference between FIG. 2G and FIG. 2H is that, in FIG. 2H the two cameras (203a, 203b) are each mounted near the back of the vehicle (201). For example, the cameras (203a, 203b) may be mounted on a trunk lid close to the typical placement of a license plate. Although the horizontal field of view angle of each of the cameras (203a, 203b) in FIG. 211 remains Θ₁, the combined field of view (209b) is reduced in area in comparison to that in FIG. 2H. Further, the blind zones created due to the placement of the cameras (203a, 203b) are larger in FIG. 2H than in FIG. 2G. As discussed above, example blind zone area calculations are described in more detail with reference to FIGS. 7A-8.

In general, the larger the horizontal field of view, the smaller the blind zone. In some, but not all cases, the closer the camera (203a) is to the front of the vehicle (201) (i.e., as close to the position of the driver (D)), the smaller the blind zone that is created because the field of view becomes larger. However, the camera (203a) should not be disposed so forward that the rear zone (207b) of the vehicle (201) obstructs the rearview of the driver. Accordingly, in one or more embodiments of the invention, the camera (203a) is disposed in a manner that enables the driver to have an adequate surrounding view of the vehicle, the surrounding view being at least one of a left side view, a right side view, and a rearview of the vehicle (201). In other words, the field of view (209) of the camera employed in the camera monitor system disclosed herein has a sideward and rearward field of view, where the sideward field of view includes a right sideward field of view and a left sideward field of view.

In one or more embodiments of the invention, image data captured by the combined field of view (209b) of the camera monitor system shown in FIGS. 2G and 2H is used to display a panoramic view covering what would conventionally be seen by a driver (D) using both the interior rear view mirror and side (wing) mirror assemblies to view the rear of the vehicle. The panoramic view is a wide-angle view showing the rear of the vehicle. By merging the views from the two rearward cameras to a very high degree of precision, a panoramic view is displayed to the driver of the vehicle. Advantageously, such a camera monitor system reduces the space requirements and increases the flexibility when fitting the camera monitor system in various vehicle types. The overall cost of the system is also reduced significantly, as the need for interior rearview and side rearview mirror assemblies may be eliminated.

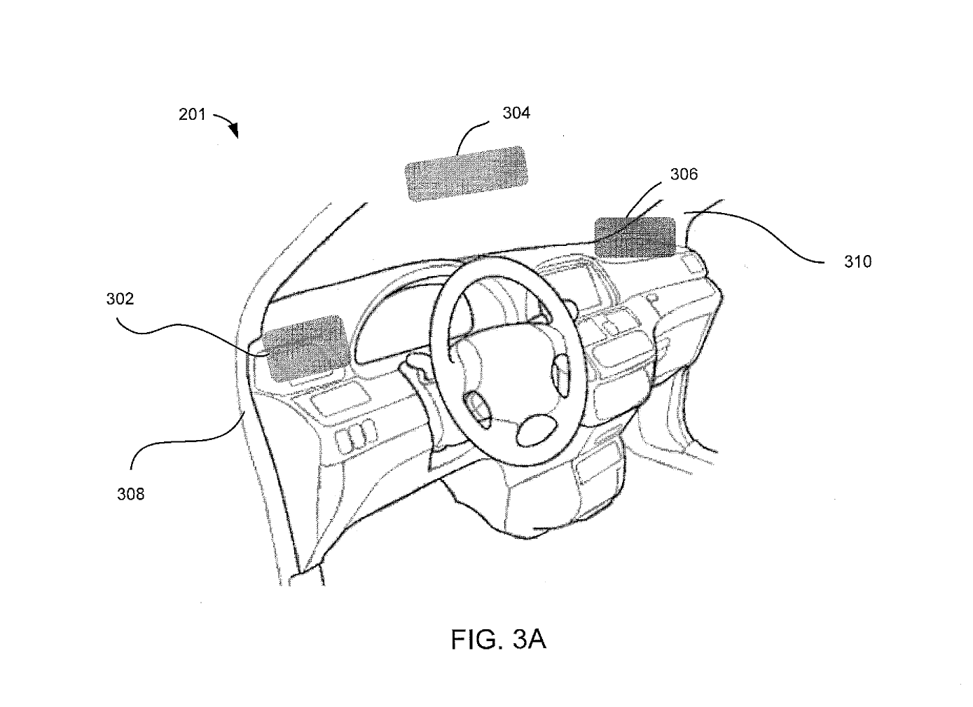

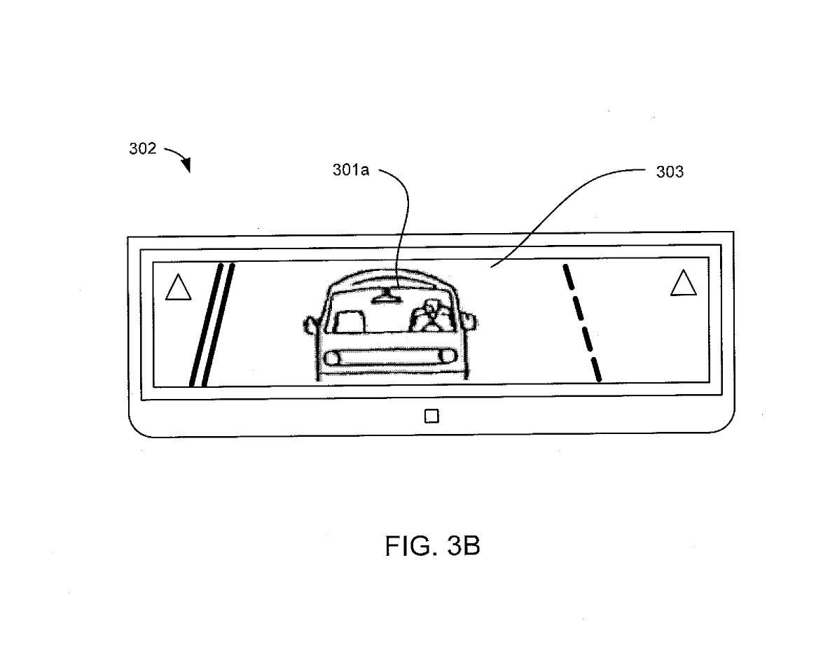

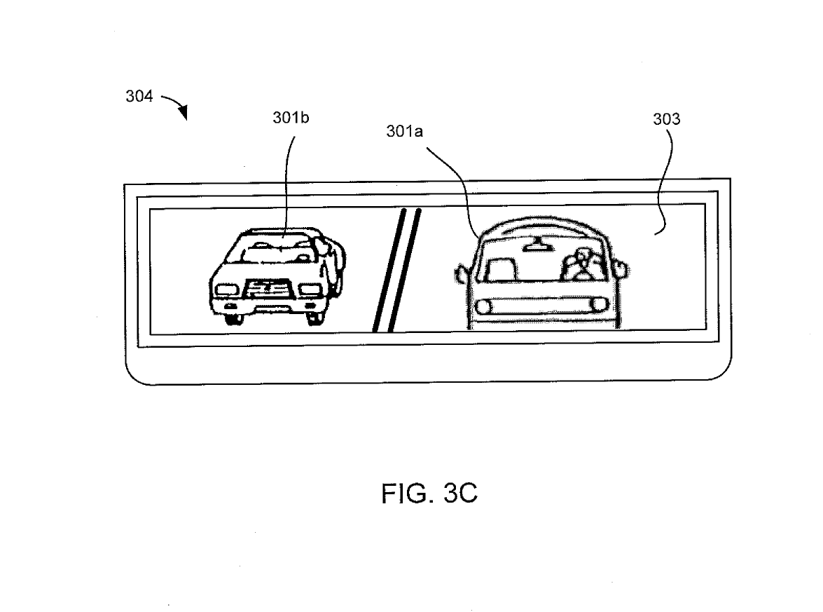

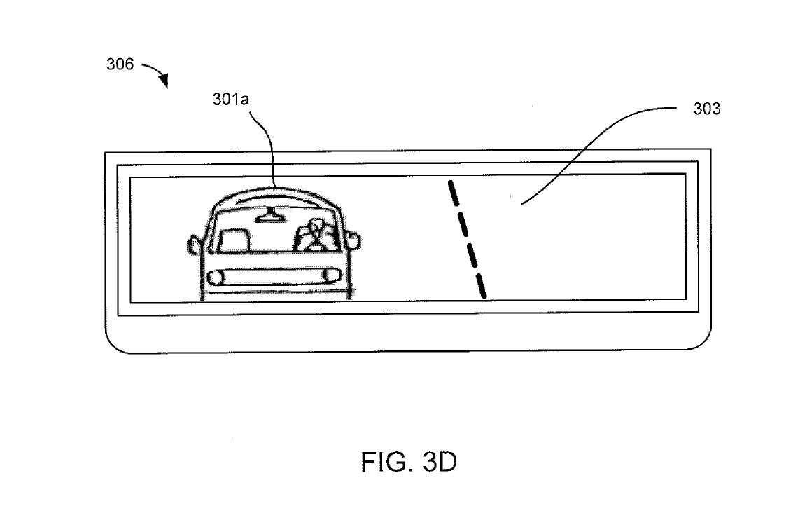

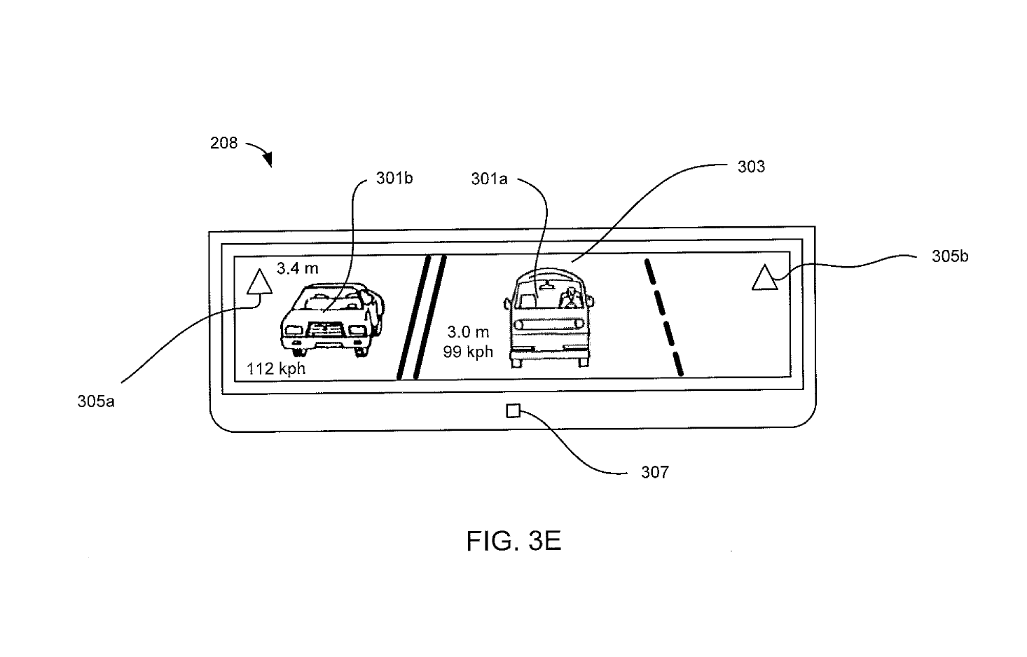

FIG. 3A shows an interior of a vehicle (201) having output devices (302, 304, 306) of the camera monitor system according to one or more embodiments of the invention. Specifically, similar to how the number of cameras of the camera monitor system can range from 1 to N (with N being any reasonable number that could satisfy regulatory requirements), the number of output devices is not limited. (Said in another way, the ratio of the number of cameras to the number of displays in a camera monitor system is N to M, where N may or may not be equal to M). In this case, the camera monitor system comprises three output devices (i.e., three displays). The three output devices (302, 304, 306) are disposed proximately to a left A-pillar (308), proximately to where conventional rearview mirrors are disposed, and proximately to a right A-pillar (310), respectively. Although the output devices (302, 304, 306) are shown to be in an interior of the vehicle (201), the output devices (302, 304, 306) may be disposed on an exterior of the vehicle (201). Further, although the output devices (302, 304, 306) are shown to be located at certain positions, one of ordinary skill in the art would recognize that the positions could be altered in view of different vehicle types, personal preferences, etc. In embodiments of the invention, the camera monitor system may comprise a video splitter used to receive a video input signal and split the video input signal such that the video input signal can be displayed on a plurality of output devices. The split may be a simple reproduction and displaying of the video input signal on a plurality of output devices. Alternatively, the split may be dividing up the video input signal according to position and displaying the various positions on various corresponding output devices. For example, the video input signal comprising a left vehicle rearview, a vehicle rearview, and right vehicle rearview may be split and displayed onto three different output devices (with each output device displaying a corresponding view). In the case where the video input signal needs to be outputted to numerous output devices, multiple video splitters may be used (i.e., placed in a cascade). Likewise, the same can be performed for an audio input signal.

In one or more embodiments of the invention, the output device (302) shows a left side view and a rear view of the vehicle. In one or more embodiments of the invention, the output device (302) is disposed such that it (302) replaces a conventional left wing mirror. In one or more embodiments of the invention, the output device (304) is disposed such that it (304) replaces a conventional rearview mirror. In one or more embodiments of the invention, the output device (304) shows a rear view of the vehicle. In one or more embodiments of the invention, the output device (306) is disposed such that it (306) replaces a conventional right wing mirror.

FIG. 3B shows the output device (302) of the camera monitor system shown in FIG. 3A. The output device (302) is configured to provide the driver with a left side view and a rearview of the vehicle.

FIG. 3C shows the output device (304) of the camera monitor system shown in FIG. 3A. The output device (304) is configured to provide the driver with a rearview of the vehicle.

FIG. 3D shows the output device (306) of the camera monitor system shown in FIG. 3A. The output device (306) is configured to provide the driver with a right side view and a rearview of the vehicle.

FIG. 3E shows an output device of the camera monitor system according to one or more embodiments of the invention. For purposes of discussion only, the output device in FIG. 3E is a display (208) that replaces Class I and Class III mirrors on a vehicle. The screen (303) of the display (208) may show not just vehicles (301a) directly behind the vehicle (201), but also other vehicles (301b) and objects of interest that are within the field of view of the camera. In one or more embodiments of the invention, the screen (303) of the display (208) may have markings that identify different zones of the rearview (e.g., left, right, etc.).

The display (208) comprises two warning icons (305a, 305b). The warning icon (305a) may illuminate when the presence of an object of interest is detected in the sensing zone (213a) of the ultrasonic sensor (211a). Likewise, the warning icon (305b) may illuminate when the presence of an object of interest is detected in the sensing zone (213b) of the ultrasonic sensor (211b). In one or more embodiments, the display (208) may comprise one or more buttons (307). The buttons (307) may enable the driver to power on/off the display (208), adjust a brightness of the display (208), adjust a resolution of the display (208), adjust a direction of the camera, display auxiliary information, etc.

In one or more embodiments of the invention, the camera monitor system is configured to detect and recognize objects of interest and display certain characteristics associated with the detected/recognized objects of interest. For example, the vehicle (301a) directly behind the equipped vehicle is traveling in the direction of the equipped vehicle at 99 kilometers per hour (KPH) and is 3.0 meters away from the equipped vehicle. For example, the vehicle (301b) in the leftmost lane is travelling in a direction opposite to that of the equipped vehicle at 112 KPH and is 3.4 meters away from the equipped vehicle. In one or more embodiments of the invention, the screen (303) may be configured to illuminate a speeding icon (not shown) or one or both of the warning icons (305a, 305b) if the processor, working in conjunction with global positioning systems (GPS), cellular networks, etc., determines that the equipped vehicle is travelling faster than a posted speed.

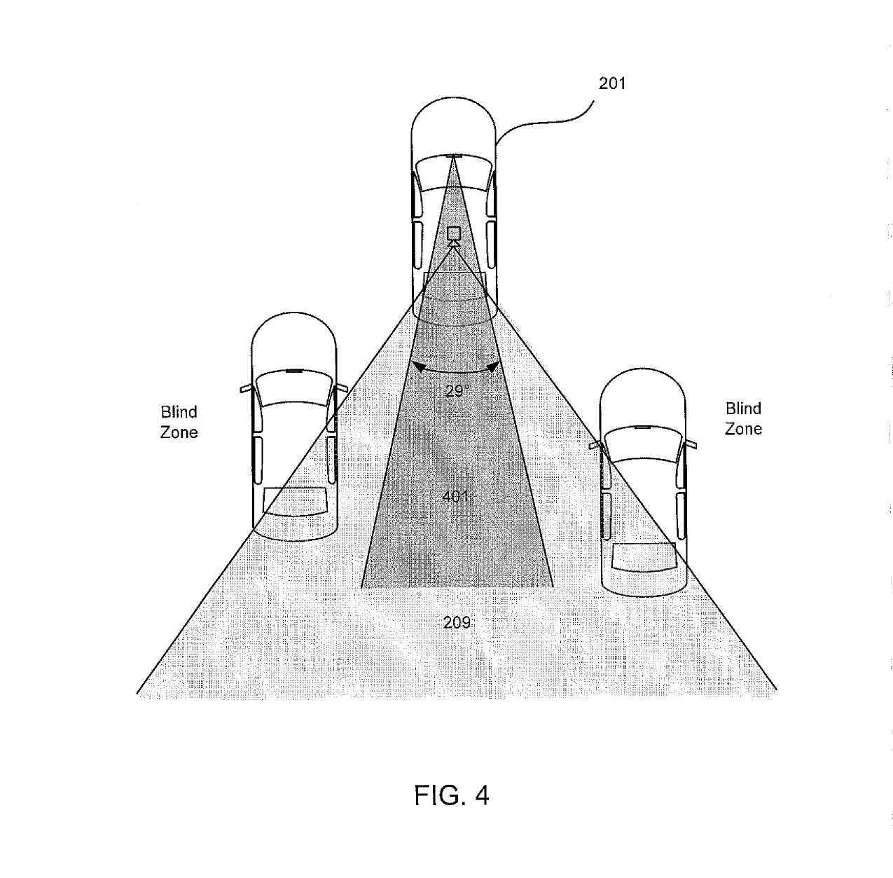

FIG. 4 shows a field of view (209) of a camera monitor system according to one or more embodiments of the invention. A camera (not shown) of the camera monitor system is mounted on the vehicle (201). Also shown in FIG. 4 is a field of view (401) of a conventional interior rearview mirror that has a horizontal field of view angle of, for example, 29°. Comparatively, the field of view (209) of the camera described in embodiments herein is greater than that of the conventional rearview mirror. Although new blind zones are created by the elimination of wing mirrors, such blind zones, as discussed above, can be minimized by appropriately positioning the camera and a sensor unit (105) of the camera monitor system.

Those skilled in the art will appreciate that FIG. 4 shows that the field of view 209 achieved by using a single camera mounted in a rear area of a vehicle is significantly larger and may replace Class I and III mirrors (i.e., the interior rear view mirror and the exterior side mirror assemblies) on conventional vehicles.

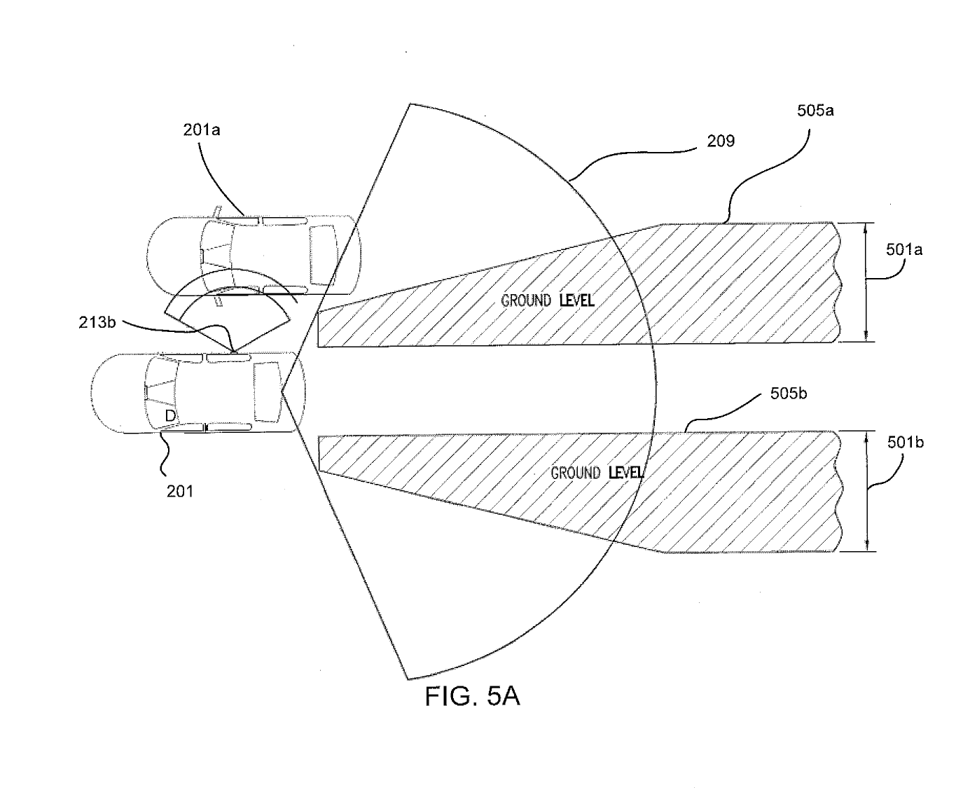

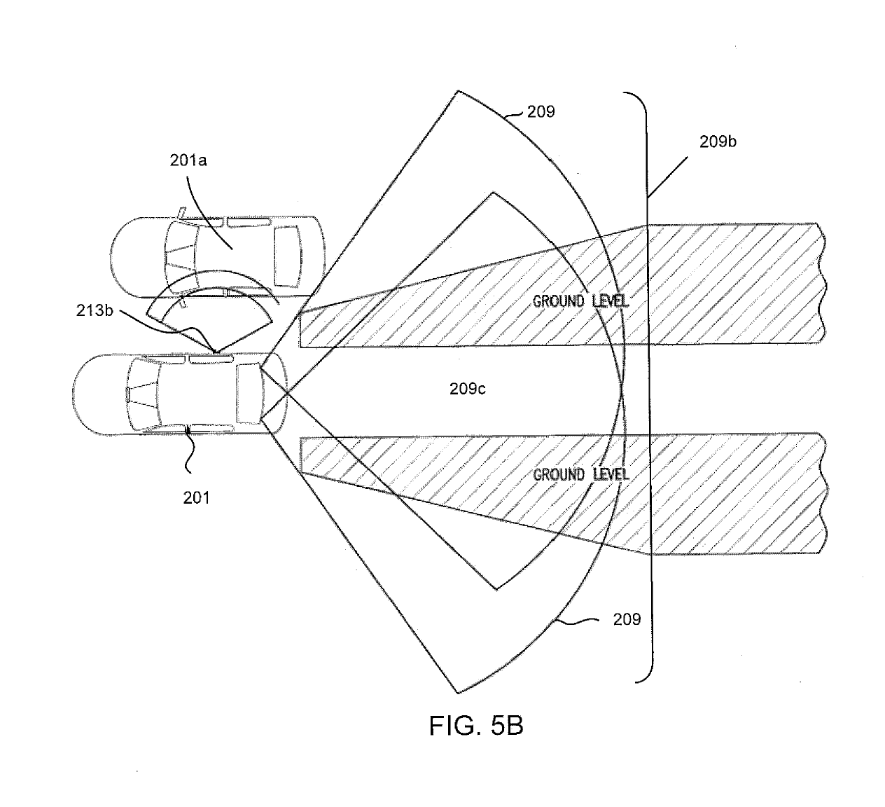

FIG. 5A shows a field of view (209) of a camera (not shown) of a camera monitor system according to one or more embodiments of the invention. The camera has a field of view (209) that overlaps with portions of hashed areas (505a, 505b). The hashed area (505a) is on a right side (R) of a vehicle (201); the hashed area (505b) is on a left side (L) of the vehicle (201). As required by the ISO 16505 Standard, Class III mirrors are required to cover at least 90% of the hashed areas (505a, 505b). At its widest, a width (501a) of the hashed area (505a) is approximately 4 meters; at its widest, a width (501b) of the hashed area (505b) is approximately 4 meters. Of course, as discussed above, one of ordinary skill in the art would appreciate that the system can be reconfigured to satisfy other regulatory requirements, including the FMVS 111.

FIG. 5A also shows another vehicle (201a) in a position too far forward to be in the field of view (209) of the camera. In this case, a sensor unit (105) having a right ultrasonic sensor (213b) and a left ultrasonic sensor (not shown) may be provided to warn the driver of the presence of the vehicle (201a) in a blind zone to the right side (R) of the vehicle (201).

FIG. 5B shows a field of view (209b) of a camera monitor system according to one or more embodiments of the invention. FIG. 5B is substantially similar to FIG. 5A.

In FIG. 5B, a camera monitor system according to one or more embodiments of the invention includes two cameras (not shown). Each of the two cameras has a field of view (209). The two field of views (209) are combined by a processor (103) into a combined field of view (209b)—the combined field of view (209b) being a union of the two field of views (209).

The combined field of view (209b) may cover a larger area of the hashed areas (505a, 505b) compared to that in FIG. 5A. The processor (103) processes image data such that objects in an overlapping field of view (209c) are not distorted and that the two field of views (209) are combined into the combined field of view (209b) seamlessly so that the driver of the vehicle (201) can view a surrounding view of the vehicle (201) with ease.

FIG. 5B also shows another vehicle (201a) in a position too far forward to be in the combined field of view (209b) of the camera. In this case, a sensor unit (105) having a right ultrasonic sensor (213a) and a left ultrasonic sensor (not shown) may be provided to warn the driver of the presence of the another vehicle (201a) in a blind zone to the right side (R) of the vehicle (201).

Whereas conventional wing mirrors create large blind zones, the camera monitor system according to one or more embodiments create blind zones ranging from 1.0 m² to 16.0 m², depending on the specification and the position of the camera.

FIG. 6A shows a vehicle (201) mounted with a camera monitor system according to one or more embodiments of the invention. Example blind zone calculations are discussed in reference to FIG. 6A. The following examples are not intended to limit the scope of the invention.

Consider the vehicle shown in FIG. 6A. The vehicle comprises characteristics listed in Table VI:

TABLE VI
Vehicle Characteristics

| | |
|---|---|
| Length | 4.6 meters |
| Width | 1.8 meters |
| Windshield to Rear | 3 meters |

Further consider that a camera having a horizontal field of view angle Θ₁ (where Θ₁=52°) is mounted on the vehicle such that a distance between the camera and the rear of the vehicle is 1.4 meters. The area of the blind zone B₂ can be computed using trigonometry.

### From FIG. 6A:

$$\begin{matrix}Θ = \frac{Θ 1}{2} & ( Equation 7.1 ) \\ a = 1.6 m + \frac{0.9 m}{tan Θ} & ( Equation 7.2 ) \\ b = \frac{a * sin {19}^{°}}{sin ( Θ - {19}^{°} )} & ( Equation 7.3 ) \\ c = \frac{a * sin Θ}{sin ( Θ - {19}^{°} )} & ( Equation 7.4 ) \\ S = \frac{( a + b + c )}{2} & ( Equation 7.5 ) \\ {B}_{2} = \sqrt{S ( S - a ) ( S - b ) ( S - c )} & ( Equation 7.6 )\end{matrix}$$

Using Equations 7.1-7.6, B₂ is approximately 6.95 m². The total blind zone (B₁+B₂) is approximately 13.9 m².

As discussed above, the larger the horizontal field of view angle Θ₁, the smaller the blind zone. Example B₂ calculations are shown in Table VII.

TABLE VII
Example Blind Zone Calculations

| Θ1 (deg) | B₂ (m²) |
|---|---|
| 50 | 8.2 |
| 60 | 4.26 |
| 70 | 2.82 |
| 80 | 2.09 |
| 90 | 1.64 |
| 100 | 1.34 |
| 110 | 1.13 |
| 120 | 0.97 |
| 130 | 0.84 |
| 140 | 0.73 |
| 150 | 0.64 |

As also discussed above, the placement of the camera can also impact the field of view and, consequently, the area of the blind zone.

FIG. 6B shows a vehicle (201) mounted with a camera monitor system according to one or more embodiments of the invention. Example blind zone calculations are discussed in reference to FIG. 6B. The vehicle in FIG. 6B also has characteristics listed in Table VI.

One difference between FIG. 6A and FIG. 6B lies in the placement of the camera. In FIG. 6B, the camera is mounted near the rear of the vehicle (201). For example, the camera may be mounted on a trunk lid close to the typical placement of a license plate. Although the horizontal field of view angle of the camera (203a) in FIG. 6B remains Θ₁, the field of view (209) that can be seen by the driver is reduced in area. Further, the blind zones (B₃, B₄) created due to the placement of the camera are larger than those of the blind zones (B₁, B₂).

The area of the blind zone B₄ can be computed using trigonometry.

### From FIG. 6B:

$$\begin{matrix}Θ = \frac{Θ 1}{2} & ( Equation 7.11 ) \\ a = 3 m + \frac{0.9 m}{tan Θ} & ( Equation 7.12 ) \\ b = \frac{a * sin {19}^{°}}{sin ( Θ - {19}^{°} )} & ( Equation 7.13 ) \\ c = \frac{a * sin Θ}{sin ( Θ - {19}^{°} )} & ( Equation 7.14 ) \\ S = \frac{( a + b + c )}{2} & ( Equation 7.15 ) \\ {B}_{4} = \sqrt{S ( S - a ) ( S - b ) ( S - c )} & ( Equation 7.16 )\end{matrix}$$

Using Equations 7.11-7.16, B₄ is approximately 13.75 m². The total blind zone (B₃+B₄) is approximately 27.5 m².

As discussed above, in some, but not all cases, the closer the camera is to the front of the vehicle, the smaller the blind zone. However, the camera should not be disposed so forward that the rear zone of the vehicle obstructs the rearview of the driver. Accordingly, in one or more embodiments, the camera is disposed in a manner that enables the driver to have an adequate surrounding view of the vehicle.

Example B₄ calculations are shown in Table VIII. Note that, for the same degree, B₄ is much larger in FIG. 6B than it is in FIG. 6A.

TABLE VIII
Example Blind Zone Calculations

| Θ1 (deg) | B₄ (m²) |
|---|---|
| 50 | 16 |
| 60 | 8.87 |
| 70 | 6.22 |
| 80 | 4.84 |
| 90 | 3.99 |
| 100 | 3.41 |
| 110 | 2.99 |
| 120 | 2.66 |
| 130 | 2.4 |
| 140 | 2.18 |
| 150 | 1.99 |

FIG. 7 shows a blind zone comparison graph for camera monitor systems according to one or more embodiments of the invention.

The graph in FIG. 7 is consistent with the above-remark that the closer the camera is to the front of the vehicle the smaller the blind zone, assuming that the camera is not obstructed by the rear of the vehicle.

While the invention has been described with respect to a limited number of embodiments, those skilled in the art, having benefit of this disclosure, will appreciate that other embodiments can be devised which do not depart from the scope of the invention as disclosed herein.

For example, although the specification describes a camera monitor system according to one or more embodiments of the invention as having one or two cameras, one of ordinary skill in the art would appreciate that the number of cameras can vary depending on vehicle type, coverage needs, regulatory requirements, etc.

For example, although the specification shows that, in a camera monitor system having a plurality of cameras, the cameras are disposed such that they align longitudinally or are symmetric with respect to a longitudinal axis of the vehicle, one of ordinary skill in the art would appreciate that the invention is not limited thereto and that the cameras may be disposed anywhere so long as regulatory requirements are met. Thus, for example, assuming that a camera monitor system comprises four cameras, a first camera may be disposed on the rear close to the driver; a second camera may be disposed on the trunk of the vehicle; a third camera may be disposed on the rear windshield inside the vehicle; a fourth camera may be disposed on the exterior of the driver's door.

For example, although camera monitor systems according to one or more embodiments are, shown in the figures, to be disposed on vehicles with certain characteristics, the invention is not limited thereto. That is, the camera monitor systems may be disposed on vehicles having wings, on vehicles without rear windshields, on vehicles without rearview mirrors, etc.

For example, although the field of view of a camera monitor system according to one or more embodiments is displayed on a display in whole (FIG. 3), the invention is not limited thereto. That is, the field of view may be divided such that a left side view of the field of view is displayed on a left wing mirror of the vehicle and that a right side view of the field of view is displayed on a right wing mirror of the vehicle.

Embodiments of the invention provide a camera monitor system in which it is possible to satisfy all official regulations with a single rearview camera positioned strategically, while at the same time covering the blind zones around the vehicle such that a driver has visibility to all relevant areas exterior to the vehicle while normally operating the vehicle. Said another way, embodiments of the invention provide a camera monitor system in which a single rearview camera replaces three cameras (i.e., the interior rearview mirror and the two exterior side-mounted rearview mirrors) while achieving the requisite field of view to comply with FMVSS 111, ISO 16505, and/or ECE R46 regulations. This is because exteriorly mounted cameras increases the field of vision by an estimated 300% over conventional interior rearview mirrors. In addition, with respect to any new blind zones occurring naturally as a result of the strategic placement of the single camera disclosed in embodiments herein, such new blind zones may be reduced optimally by opening the FoV of the camera sufficiently. Further, the minimally reduced new blind zones resulting from embodiments of the invention are irrelevant for the functionality of system.

In one or more embodiments of the invention, by strategically placing one or two rear-mounted, rearview cameras, a panorama of the rear of the vehicle is achieved for display to the driver, thereby eliminating the need for three rearview cameras required in the standard which define Class I and Class III mirrors.

Furthermore, one of ordinary skill in the art would appreciate that certain “components,” “modules,” “units,” “parts,” “elements,” or “portions” of the one or more embodiments of the invention may be implemented by a circuit, processor, etc., using any known methods. Accordingly, the scope of the disclosure should be limited only by the attached claims.

1. A camera monitor system for a vehicle, comprising:
a single camera disposed on a rear of the vehicle comprising a field of view (FoV), wherein the FoV is a rearview comprising a horizontal FoV angle ranging from 50° to 150°;
a processor configured to process image data received by the single camera to obtain an image of a vehicle surrounding;
an output device configured to display the image of the vehicle surrounding; and
a sensor unit configured to output a signal, wherein the output device is configured to display the signal to warn a driver of the vehicle of presence of an object in a blind zone outside of the FoV and inside a sensing zone of the sensor unit.

2. The system according to claim 1, wherein the rear is a rearmost area on a roof just before where a rear windshield starts.

3. The system according to claim 1, wherein the rear is a back area where a license plate is configured to be disposed.

4. The system according to claim 1, wherein the FoV comprises a vertical FoV angle ranging from 15° and 70°.

5. The system according to claim 1, wherein the output device is one selected from the group consisting of: three separate displays, a replacement for a rearview mirror disposed on the vehicle, a dual display within a rearview mirror disposed on the vehicle, and a portion of a windshield of the vehicle.

6. The system according to claim 1, wherein the vehicle is without a wing mirror, without a rear mirror, and without a rear windshield.

7. The system according to claim 1, wherein the image of the vehicle surrounding is a rear panoramic view comprising the rearview, a left side view, and a right side view to a driver operating the vehicle.

8. The system according to claim 1, wherein the image of the vehicle surrounding complies with requirements of the FMVSS 111 standard and the ECE R46 regulation.

9. (canceled)

10. The system according to claim 1, wherein, when the single camera images an object of interest, the image comprises at least one of a speed of the object of interest, a distance between the object of interest and the vehicle, and a license plate information of the object of interest.

11. A camera monitor system for a vehicle, comprising:
a first camera disposed on a rear of the vehicle comprising a first field of view (FoV), wherein the first FoV is a first rearview;
a second camera disposed on the rear of the vehicle comprising a second FoV, wherein the second FoV is a second rearview;
a processor configured to process the first FoV and the second FoV to obtain an image of a vehicle surrounding, wherein the combined FoV comprises a horizontal FoV angle ranging from 50° to 300°; and
an output device is configured to display the image of the vehicle surrounding,
wherein the rear of the vehicle is a rearmost area on a roof just before a rear windshield.

12. (canceled)

13. (canceled)

14. The system according to claim 11, wherein the combined FoV comprises a vertical FoV angle ranging from 15° and 70°.

15. The system according to claim 11, wherein the output device is one selected from the group consisting of: three separate displays, a replacement for a rearview mirror disposed on the vehicle, a dual display within a rearview mirror disposed on the vehicle, and a portion of a windshield of the vehicle.

16. The system according to claim 11, wherein the vehicle is without a wing mirror, without a rear mirror, and without a rear windshield.

17. The system according to claim 11, wherein the image of the vehicle surrounding is a rear panoramic view comprising the rearview, a left side view, and a right side view to a driver operating the vehicle.

18. The system according to claim 11, wherein the image of the vehicle surrounding complies with requirements of the FMVSS 111 standard and the ECE R46 regulation.

19. The system according to claim 11, further comprising a sensor unit configured to output a signal, wherein the output device is configured to display the signal to warn a driver of the vehicle of presence of an object in a blind zone outside of the FoV and inside a sensing zone of the sensor unit.

20. (canceled)

21. A monitoring method comprising:
disposing a single camera on a vehicle, the single camera having a field of view (FoV);
determining that an object of interest has entered the FoV; and
displaying a view of the external environment of the vehicle, wherein the view includes the object of interest, on an output device,
wherein the FoV is a rearward view comprising a horizontal FoV angle ranging from 50° to 150°, and
wherein the view displayed on the output device complies with requirements of the FMVSS 111 standard and the ECE R46 regulation.

22. The monitoring method according to claim 21, further comprising:
disposing a sensor unit on the vehicle such that a sensing zone of the sensor unit is outside of the field of view; and
illuminating a warning icon when the sensor unit determines that the object of interest has entered the sensing zone.

23. The monitoring method according to claim 21, wherein the vehicle is without a wing mirror, without a rear mirror, and without a rear windshield.

24. The monitoring method according to claim 21, wherein the displaying further comprises displaying at least one of a speed of the object of interest, a distance between the object of interest and the vehicle, and a license plate information of the object of interest.

25. (canceled)

26. The monitoring method according to claim 21, wherein the output device is one selected from the group consisting of: three separate displays, a replacement for a rearview mirror disposed on the vehicle, a dual display within a rearview mirror disposed on the vehicle, and a portion of a windshield of the vehicle.

27. The system according to claim 1, wherein:
the output device comprises a left display, a center display, and a right display,
the left display is disposed on a left A-pillar and displays a left side view,
the center display is a replacement for a rearview mirror and displays a rear view, and
the right display is disposed on a right A-pillar and displays a right side view.

28. The system according to claim 1, wherein the single camera is not disposed on a longitudinal center axis of the vehicle.

29. The monitoring method according to claim 21, wherein the single camera is disposed on a rear windshield inside the vehicle.
